(19) United States
(12) Patent Application Publication
(10) Pub. No.: US 2010/0241623 A1
(43) Pub. Date: Sep. 23, 2010

(54) USER GENERATED NOTES INTEGRATED WITH LOCATION-BASED APPLICATION

(76) Inventors: Robert L. Acker, Redwood City, CA (US); Rafael Saavedra, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/729,123

(22) Filed: Mar. 22, 2010

Related U.S. Application Data
(60) Provisional application No. 61/162,578, filed on Mar. 23, 2009.

(51) Int. Cl. G06F 17/30

(52) U.S. Cl. 707/724; 707/769; 707/E17.014; 707/E17.017

(57) ABSTRACT

A system and method are disclosed for displaying geographically and/or temporally relevant multimedia notes on a mobile client device. The user creates a multimedia note through the mobile client device and transmits the note to the server. The server publishes the note and when the note becomes geographically and/or temporally relevant for other users, the server transmits the note to mobile client devices of those users. The server also tracks the route of a mobile client device and generates a web presentation with the tracked route including the multimedia notes embedded in various locations of the route.

### CROSS-REFERENCE To RELATED APPLICATION

This application claims the benefit of U.S. Provisional Application No. 61/162,578, filed Mar. 23, 2009, which is hereby incorporated by reference in its entirety

### BACKGROUND

1. Field of Art

The disclosure generally relates to the field of location tracking, and more specifically, to providing relevant user generated data to a client in a format that is sensitive to demands on a vehicle user.

2. Description of the Related Art

Global positioning system (GPS) devices are becoming ubiquitous. As the technology becomes more affordable, the GPS device is becoming an integral part of navigation, for example, in a vehicle. A GPS device can have complex maps with a variety of options for use with navigation. While these maps and options can be helpful to a driver (e.g., the user), the GPS device also can become a distraction for a driver and divert the driver from their driving responsibilities.

Studies have shown that a driver driving at 30 kilometers per hour (kmph) can safely look at a navigation device for a maximum of 4.2 seconds to extract information from the device. Additionally, a driver can read an average of only eleven roman characters per second. Accordingly, a GPS device with complex maps can become a hazardous distraction when the drivers repeatedly search for directions and other options on the client device. For example, a driver driving down a calculated route will have to enter new information in the GPS device if the driver takes a detour from the calculated route. Moreover, if the driver wants additional information like traffic information for a detour, the driver has to select additional options on the GPS device. Typically, to access the additional option requires a driver to either stop and enter all this new information or, more problematically, enter all this new information while driving. The latter scenario diverts attention from the road.

Moreover, the selected information may not be the most updated and most relevant information. For example, traffic incident information is collected from a variety of sources like radio reporters that can only be in so many places at any given time. The traffic information, therefore, is incomplete, limited in geographical coverage and often outdated. Further, the current systems are focused on traffic information for major highways and not on information for other roads.

### BRIEF DESCRIPTION OF DRAWINGS

The disclosed embodiments have other advantages and features which will be more readily apparent from the detailed description, the appended claims, and the accompanying drawings, in which:

Figure (FIG.) 1 illustrates one embodiment of system that delivers temporally and/or geographically relevant multimedia notes to a client device.

FIG. 2 illustrates one embodiment of architecture of a server that helps generate and deliver temporally and/or geographically relevant multimedia notes to a client device.

FIG. 3 illustrates one embodiment of architecture of a mobile client device that helps generate and deliver temporally and/or geographically relevant multimedia notes to a client device.

FIG. 4A illustrates one embodiment of a method for processing multimedia notes at the server.

FIG. 4B illustrates one embodiment of a method for receiving and displaying temporally and/or geographically relevant multimedia notes on the mobile client device.

FIG. 4C illustrates one embodiment of a method for determining multimedia notes for mobile client device based on current location of the mobile client device and the search criteria transmitted from the mobile client device.

FIG. 5 illustrates one embodiment of a method for creating and publishing web content with user generated multimedia notes.

FIGS. 6A-6C illustrate examples of user interface screens available on mobile client device for communicating information to and from a user of mobile client device.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles disclosed herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of the disclosed system and method includes a mobile client and server for generating and serving location specific multimedia (or media) notes that are made available to the users when they desire access to the multimedia notes, for example, when they become temporally and/or geographically relevant for the user.

A user can use the mobile client device to generate multimedia notes and associate location coordinates and time of creation with the note. The generated note and its associated metadata are then transmitted to the server. The server processes the received notes and determines if the notes are suitable for publishing. If the notes are not suitable for publishing, the notes are stored for analysis like determining the note generator's preference. Otherwise, the notes are published and are made available for users.

Users can now access the published note, for example, as the multimedia note becomes temporally and/or geographically relevant for them. Other examples of when the note may be accessed by a user is when they seek access to notes left by a particular creator, on a particular subject, or related to a particular event. The users can enter search criteria on their mobile client device and the mobile client device transmits the search criteria and its current location to the server or the user may not enter a search criteria and the server uses a default search criteria to determine the relevant notes. The mobile client device continually transmits its current location to the server as the mobile client device moves and its current location changes.

The server receives the changing current location of the mobile client device and determines the geographically relevant multimedia notes that have associated location coordinates in vicinity of the current location of the mobile client device. The server transmits the determined multimedia notes to the mobile client device and the mobile client device renders the multimedia notes for the user once the mobile client device comes within a predetermined distance of the location coordinates associated with the multimedia note. In one embodiment, the server initially transmits a thin layer of metadata associated with the determined notes and later transmits the content of the multimedia notes once the multimedia note is more likely to be rendered by the client. In one embodiment, the multimedia note becomes more likely to be rendered as the user approaches the geographical location associated with the note.

In one embodiment, the server also determines the temporal relevance of multimedia notes before transmitting the notes to the mobile client device. If the multimedia note was created or updated within a predetermined duration of searching for the note, the server transmits the note to the mobile client device. Otherwise, the server does not transmit the multimedia note to the mobile client device.

In one embodiment, the multimedia notes are served on demand to the user even if they are not temporally or geographically relevant. A user can request multimedia notes based on criteria like note subject, preferred creator, etc. In these cases, the server searches and transmits notes that meet the user's criteria even if the notes are not temporally or geographically relevant. For example, a user in Virginia can request all the notes on a freeway in LA because the user once lived there, or users can request notes created by their preferred note creators whenever the notes become available even if the notes aren't geographically relevant.

Additionally, the user can create a visual representation, like an animation or an interactive multimedia representation, of their route with embedded multimedia notes using one embodiment of the disclosed system. The server in the disclosed system tracks the route of the user's mobile client device and the notes generated through the mobile client device while traversing the route. The server then creates a web presentation with a visual representation of the route. The server next embeds the notes at appropriate points in the visual representation such that the notes are rendered when the embedded part of the representation is highlighted. After completing the presentation, the server publishes the presentation on a user's website, for example, a MYSPACE or FACEBOOK web page, AHAMOBILE website, YOUTUBE web page or the like. In one embodiment, the multimedia notes that a user creates are sent as MMS messages to a location or recipient that the user designates.

### Example Network

Figure (FIG. 1 illustrates one embodiment of a system 100 that delivers temporally and/or geographically relevant information to a client device. The system 100 includes a mobile client device 102, a wireless network 104, a server 106, a map database 108, a user database 110, a searchable content database 112 and an external searchable source 114. The mobile client device 102 communicatively couples to server 106 through wireless network 104. The server 106 communicatively couples to external searchable source 114, map database 108, user database 110 and searchable content database 112 through wireless network 104 or another wired or wireless network.

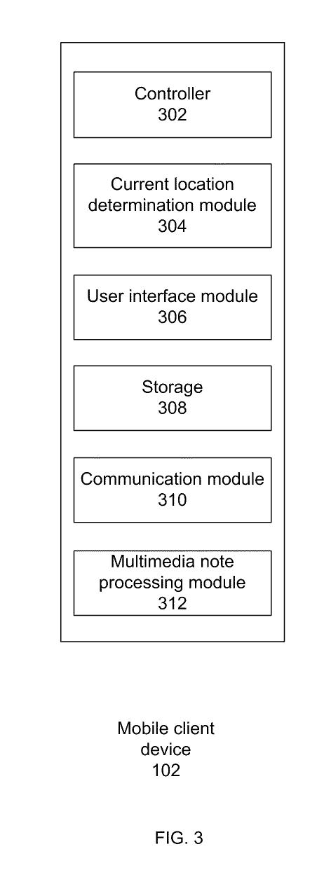

The mobile client device 102 is a hardware, software, firmware or a blended implementation that is capable of determining its geographic location and transmitting its location to server 106 through a wireless network 104. The mobile client device 102 also provides a user interface to render information received from server 106 for the device user. In one embodiment, the mobile client device 102 is a standalone device that performs part or all of the features disclosed in this application. In another embodiment, the mobile client device 102 is a mobile phone, a global positioning system (“GPS”) device or another mobile device capable of wirelessly communicating with server 106 that implements part or all of the disclosed features in addition to other application features. The mobile client device 102 is further explained in detail with respect to FIG. 3.

The wireless network 104 is a collection of networking devices that enables its connected entities to wirelessly communicate with each other. The wireless network can be a wireless personal area network, wireless local area network, wireless metropolitan area network or a mobile device network, for example, global system for mobile communications (GSM), personal communications service (PCS) network or digital advanced mobile phone service (D-AMPS) network.

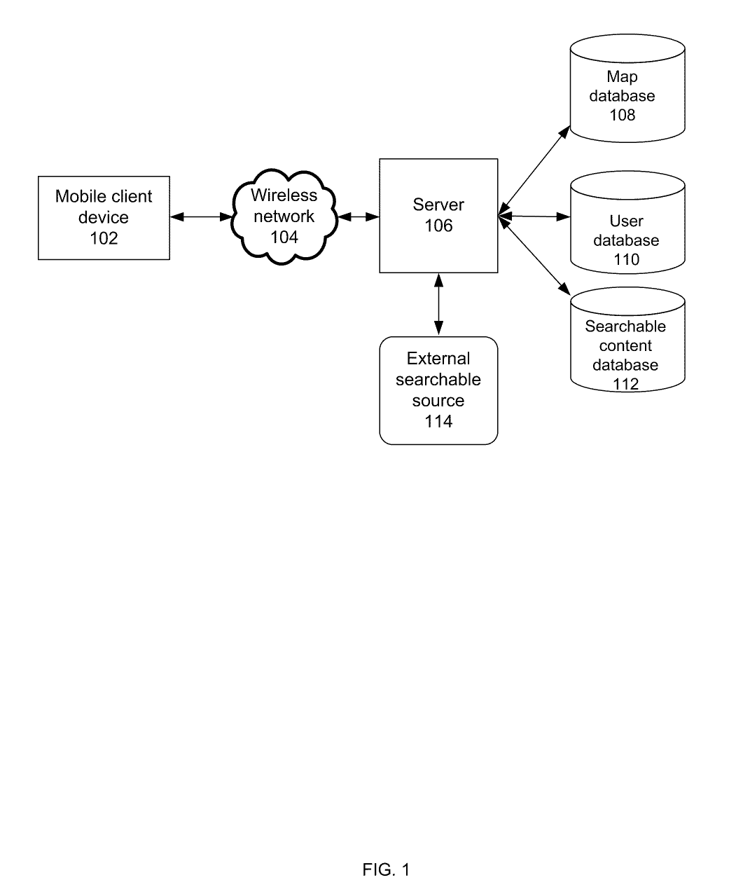

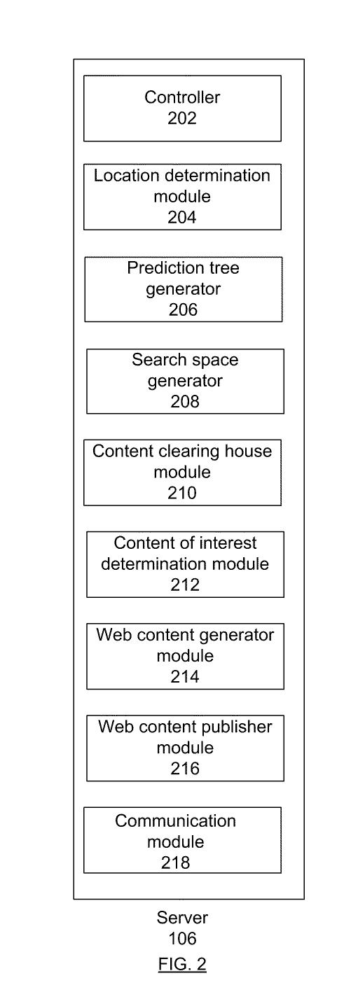

Server 106 is a hardware, software, firmware or a blended implementation that receives the location of mobile client device 102, determines the temporally and/or geographically relevant information for transmission to mobile client device 102 and transmits the determined information to mobile client device 102. Server 106 searches for relevant information from various databases communicatively coupled to server 106. In one embodiment, server 106 also receives and stores multimedia notes generated by users of mobile device 102. Server 106 is described in detail in FIG. 2.

Map database 108 includes hardware, software, and/or firmware configured to implement a database that stores map data representing a road network and named areas, such as cities and metropolitan areas, with associated features like points of interest. The map database, in one embodiment, includes named geographic areas and/or basic elements of road network, like nodes and area between the nodes, and properties of those elements like location coordinates, shape, addresses, road class, speed range etc.

User database 110 includes hardware, software, and/or firmware configured to implement a database comprising information about various users of mobile client device 102. The information includes a user identification (id), name, access credentials for external services, such as e-mail, FACEBOOK, MYSPACE etc., associated groups and associated friends of a user. User database 110 can comprise additional information like user preferences, user's past search criteria and user's frequently visited points of interest.

Searchable content database 112 includes hardware, software, and/or firmware configured to implement a database comprising content searched by server 106 and transmitted to mobile client device 102. The searchable content database 112 can comprise of content generated by users of mobile client device 102. In one embodiment, the generated content comprises one or more from the group of multimedia notes generated by a user, geographical coordinates associated with the multimedia note, a category for the multimedia note, a user community rating and the time the user generated the note.

External searchable source 114 includes hardware, software, and/or firmware configured to implement a database comprising additional information regarding a geographical location generated by users of various other devices and applications. For example, the information can comprise geographically tagged information with user generated audio, visual, or textual notes. The information may also include information from external services accessible through a network, for example, BING or YAHOO search, CITYSEARCH, or YELP. In one embodiment, the external searchable source is an external service that provides relevant content through network 104 or a wired network.

### Example Server Architectural Overview

FIG. 2 illustrates one embodiment of architecture of a server 106. Server 106 is responsible for determining the location of mobile client device 102 and transmitting temporally and/or geographically relevant information to mobile client device 102. In one embodiment, server 106 also generates and publishes on a web site content comprising information generated by user of mobile client device 102.

Server 106 comprises a controller 202, location determination module 204, prediction tree generator 206, search space generator 208, content clearing house module 210, content of interest determination module 212, web content generator module 214, web content publisher module 216 and communication module 218. All these modules are communicatively coupled to each other through a communication bus.

Controller 202 is a hardware, firmware, software or blended implementation that directs other modules in server 106 to implement their respective tasks in response to an event or receiving a particular message. In one embodiment, controller 202 implements the state machine of server 106.

Location determination module 204 is a hardware, firmware, software or blended implementation that determines the location of mobile client device 102 on a road network map. In one embodiment, the location determination module 204 repeatedly receives the location coordinates of the mobile client device 102 from mobile client device 102. The location determination module 204 uses these received coordinates and, if available, its heading and speed to locate the client device 102 on a road network map.

Prediction tree generator 206 is a hardware, firmware, software or blended implementation that determines the potential routes for mobile client device 102 based on a current location of mobile client device 102 and/or a destination location transmitted by mobile client device 102 to server 106. The prediction tree generator 206 keeps updating the possible routes for a mobile client device 102 as the mobile client device moves from one location to another. For example, the user can enter a destination location. The prediction tree generator 206 determines potential routes to the destination for a user. In one embodiment, the user of mobile client device 102 does not specify a destination location and the prediction tree generator searches for potential routes based on the current location of the mobile client device 102. In one embodiment, the prediction tree generator 206 also uses the current heading or the current speed of the client device 102 to determine the potential routes. To determine potential routes, the prediction tree generator 206 selects from the road network map the road segments that most closely match the user's position and heading. The prediction tree generator 206 then follows the road connections from those road segments to other road segments that the user can reach in a given time limit, therefore tracing the possible paths that the user can follow in that time limit. The result of this road tracing is an ordered set of connected road segments that make up the potential routes that the user can follow. The above illustrated technique is one example of predicting potential routes and this illustrated technique is not meant to limit the prediction tree generator 206 to the illustrated technique. Instead, one of ordinary skill in the art will realize that the prediction tree generator 206 can implement various other techniques to predict potential routes. As the current location of the mobile client device 102 changes, the prediction tree generator recalculates or updates the potential routes that can be taken by a user of mobile client device 102.

Search space generator 208 is a hardware, firmware, software or blended implementation that uses the potential routes determined by prediction tree generator 206 and determines the search area that should be searched by content of interest determination module 212 for content of interest. In one embodiment, the search space generator 208 determines the search area by defining circles around the major intersections (for example freeway exits or avenue crossings) within the potential routes. In this case the resulting search area is a set of circular areas that can be used by the content of interest determination module 212 as search space to search for content of interest. The above illustrated technique is one example of determining a search space and this illustrated technique is not meant to limit the search space generator 208 to the illustrated technique. Instead, one of ordinary skill in the art will realize that the search space generator 208 can implement various other techniques to determine a search space.

Content clearinghouse module 212 is a hardware, firmware, software or blended implementation that receives, classifies and stores content from various mobile client devices 102 in searchable content database 112. For example, a user of mobile client device 102 can record and transmit an audio note for a particular location to server 106. The content clearing house module 210 on receiving the content determines if the content quality and nature of the content is publishable or not. The content clearing house module 210 can also enhance the quality of content through post processing techniques like removing the background noise from the content or equalizing the sound levels etc. Additionally, the content clearing house module 210 can classify the received content based on the individual or group of content generators or the nature of the generated content. For example, the content can be an audio note about traffic at a given location at a certain time.

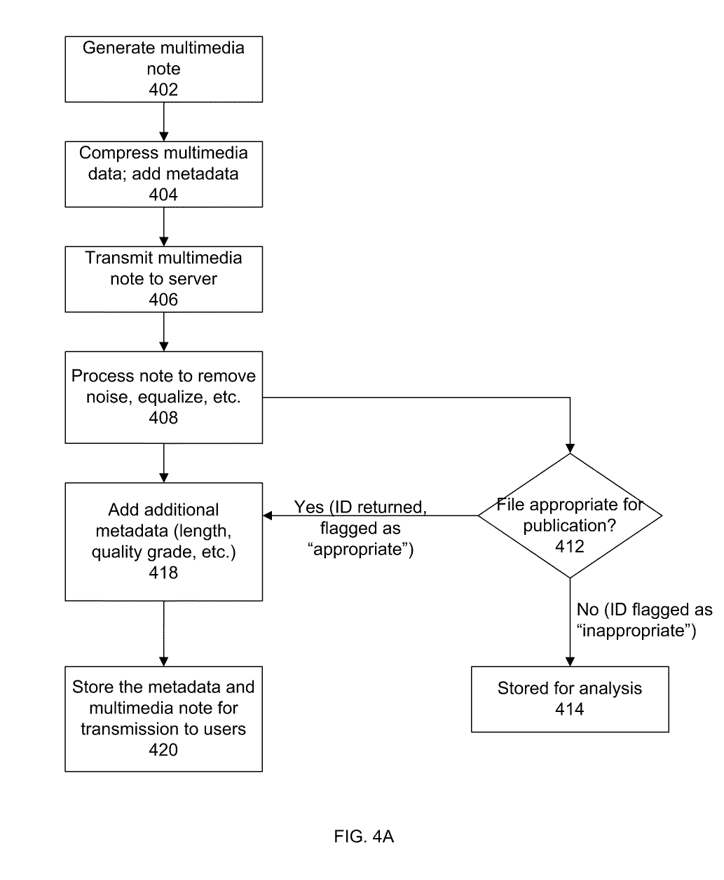

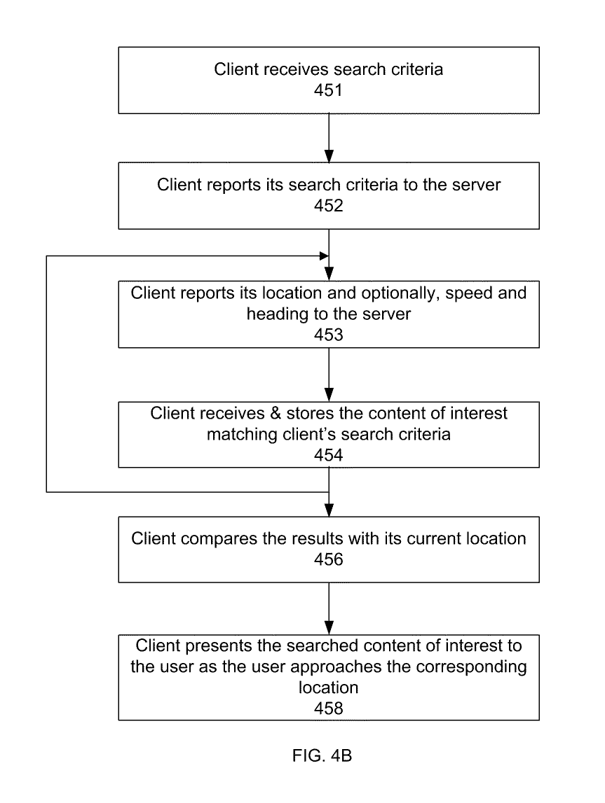

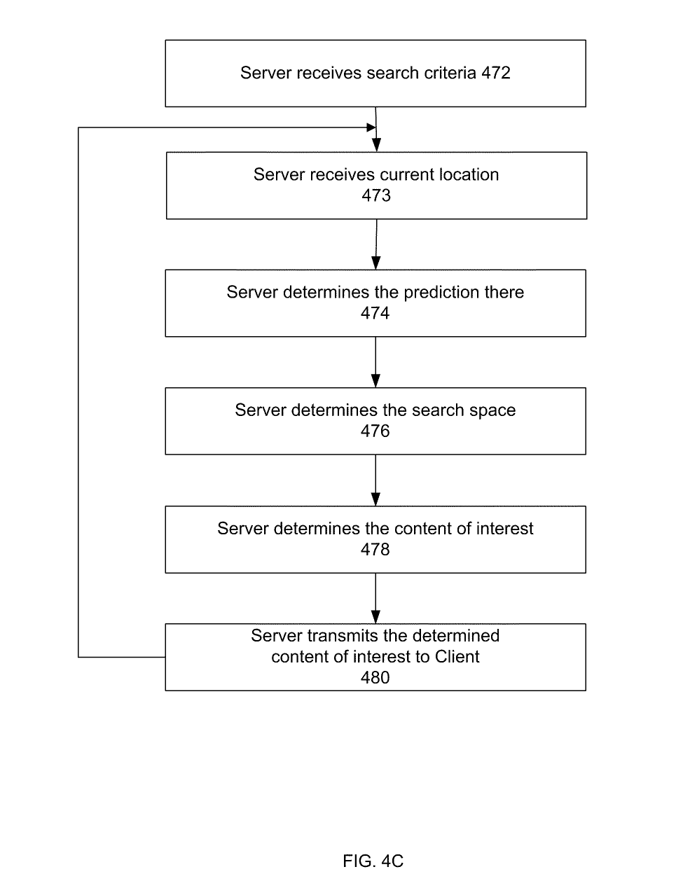

In one embodiment, the content clearing house (or clearinghouse) module 212 outsources some or all of its functions to third party services. The content clearing house module therefore transmits the content or a location of content to a third party module. The third party modules performs functions like determining the quality of the content, classifying the content etc. and transmit the results to the content clearinghouse module 212. The functions of content clearing house module 212 are also explained in FIG. 4A below.

Content of interest determination module 212 is a hardware, firmware, software or blended implementation that searches searchable content database 112, user database 110 and external searchable source 114 to determine the content that is of interest to a particular user of mobile computing device 102. The content of interest determination module 212 uses a default search criteria or a search criteria provided by user of mobile client device 102 to determine the content of interest corresponding to the search criteria, within the search area provided by the search space generator 208. The default search criteria can comprise restaurants, gas stations and rest areas on a predicted route.

In one embodiment, the content of interest module 212 does not limit its searches to the determined search space and searches a different relevant location. For example, the search space for a mobile client device 102 located in bay area may not extend to the long beach area. However, if the user through mobile client device 102 requests content of interest related to long beach area, the content of interest determination module 212 searches for content related to long beach area that meets the user's search criteria or a default search criteria. In another embodiment, the content of interest module 212 does not limit its searches to a specific location, but uses other search criteria like content created by highly rated users or friends of the individual currently using the device.

Web content generator module 214 is a hardware, firmware, software or blended implementation that creates a movie or presentation in a format that can be displayed on a web site. The presentation includes a visual or audio representation of a route taken by a user of the mobile client device 102 and accompanying audio notes or other multimedia notes created by the user through mobile client device 102. In one embodiment, the web content generator module 214 generates the presentation using HyperText Markup Language (HTML) and a scripting language like JAVASCRIPT™. In another embodiment, the web content generator module 214 generates a digital video representing the movement of the mobile client device 102 on a map and reproducing along the way the audio notes or multimedia notes created by the user through the mobile client device 102.

Web content publisher module 216 is a hardware, firmware, software or blended implementation that publishes the web content generated by web content generator module 214 on a web site. The web content publisher module 216 uses authorization information provided by user of mobile client device 102 and application programming interfaces (APIs) provided by a website to access a user's web site or other web-based content publishing service, such as a video publishing service or a social network service, and publishes the generated web content on the service or directly on the website.

Communication module 218 is a hardware, firmware, software or blended implementation that provides a communication channel for various modules in server 106 to communicate with other entities in system 100. The communication module is communicatively coupled to mobile client device 102, external searchable source 114, map database 108, user database 110 and searchable content database 112.

### Example Client Architectural Overview

FIG. 3 illustrates one embodiment of architecture of mobile client device 102. Mobile client device 102 is responsible for transmitting to server 106 its current location, search criteria specified by a user and multimedia notes generated by the user. In one embodiment, the mobile client device 102 also receives temporally and/or geographically relevant information from server 106 and renders the appropriate information for the user.

Mobile client device 102 comprises a controller 302, a current location determination module 304, a communication module 310, a storage module 308, a user interface module 306 and a multimedia note processing module 312. All these modules are communicatively coupled to each other through a communication bus.

Controller 302 is a hardware, firmware, software or blended implementation that directs other modules in mobile client device 102 to implement their respective tasks in response to an event or receiving a particular message. In one embodiment, controller 302 implements the state machine of mobile client device 102.

The current location determination module 304 is a hardware, firmware, software or blended implementation that determines the current coordinates of mobile client device 102. In one embodiment, the current location determination module communicatively couples to one or more satellites in a global positioning system (GPS). The current location determination module 304 determines the location of mobile client device 102 by communicating with these satellites. The method for determining a current location with the help of a GPS is well known in the art. In another embodiment, the current location determination module communicatively couples to a GPS device and determines the current location of mobile client device 102 through the GPS device. In one embodiment, the current location determination module 304 also determines the speed and heading direction of client 102 through the GPS device or by communicating with GPS satellites.

The current location determination module 304 can also use various other methods like cellular, Wi-Fi, other position determination technology, or a combination of these technologies to determine the current location of the mobile client device 102.

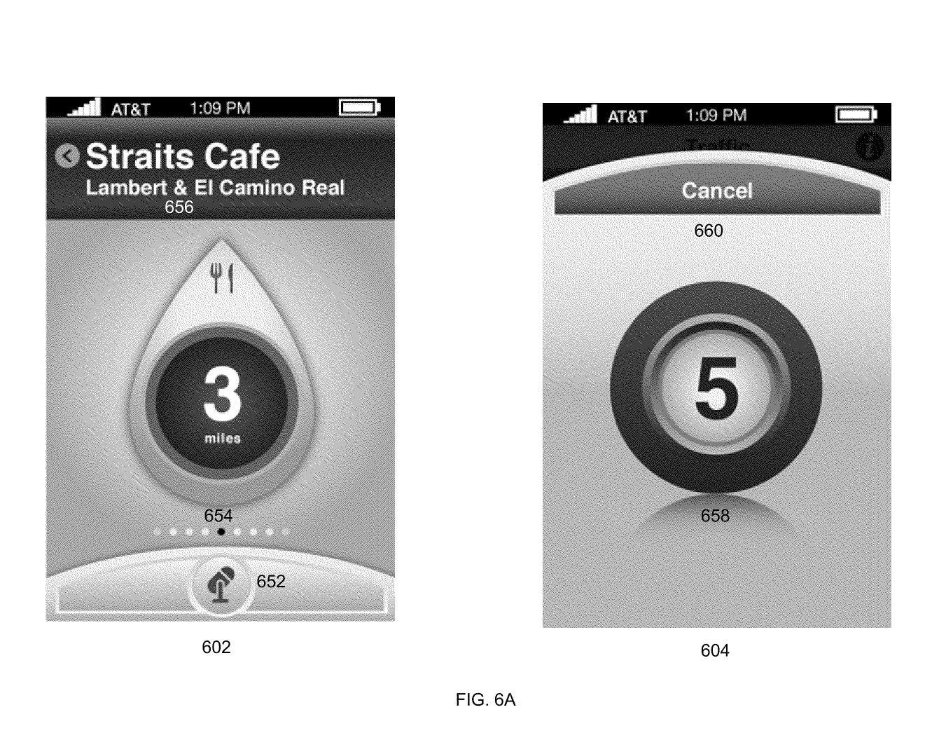

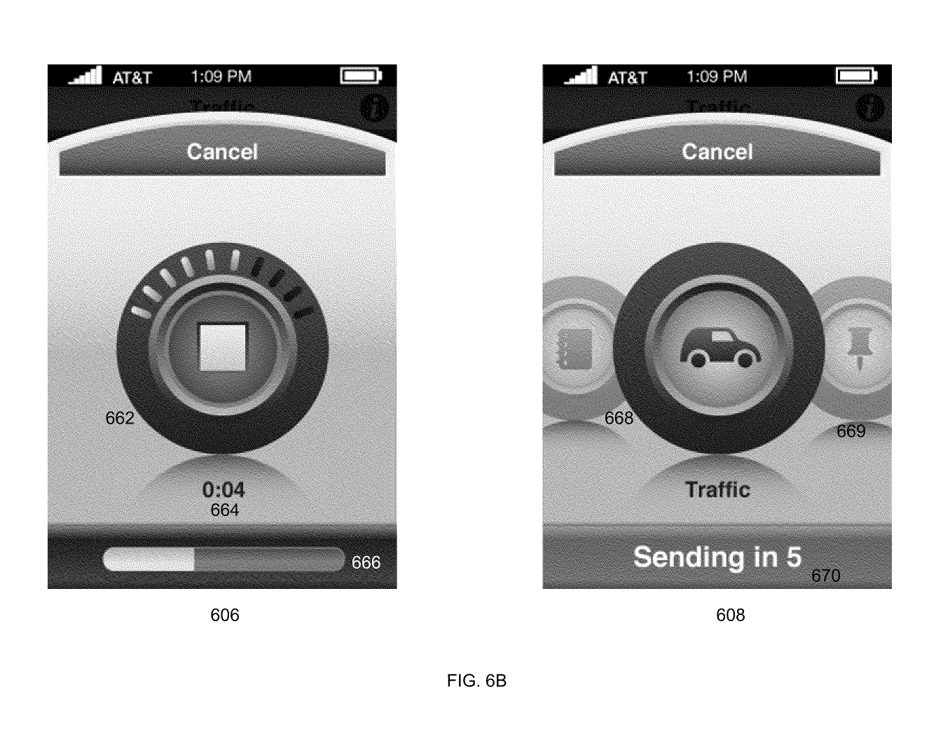

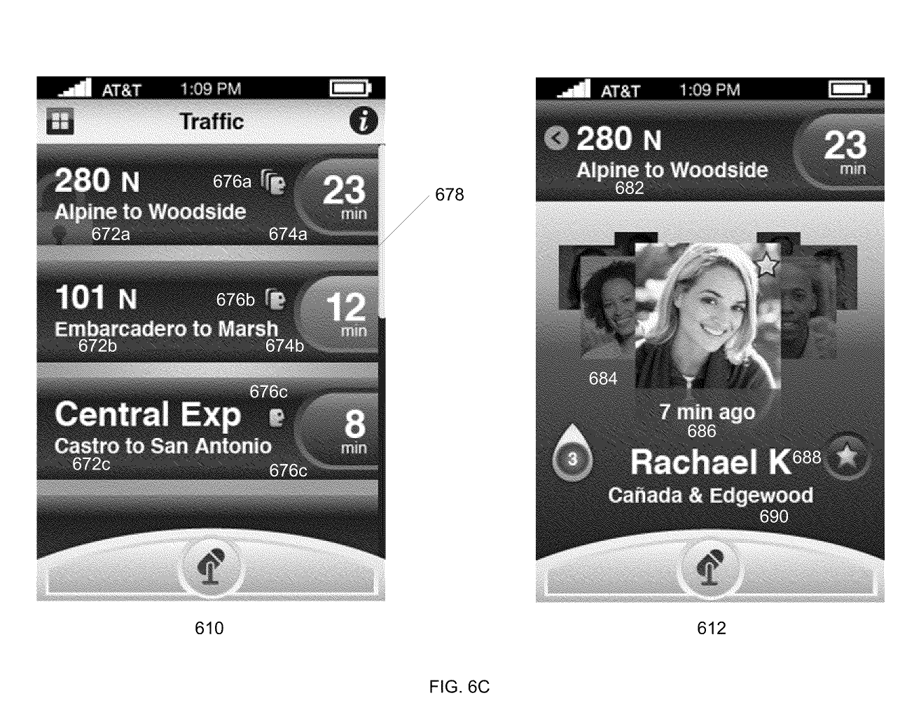

The user interface module 306 is a hardware, firmware, software or blended implementation that controls the user interface that renders the temporally and/or geographically relevant information received from server 106. The user interface module 306 also provides the user with an interface to create and transmit multimedia notes to server 106. In one embodiment, the user interface module 306 also controls user interface that allows the users to enter their search criteria and generated multimedia notes. Examples of user interface screens available on the mobile client device are explained below with respect to FIGS. 6A-6C.

The multimedia note processing module 312 is a hardware, firmware, software or blended implementation that processes the generated and received multimedia notes. The multimedia note processing module 312 comprise an encoder to encode or compress the multimedia notes generated by a user into a compressed video or audio format like MPEG1, MPEG2, and MPEG4, IMA-ADPCM, iLBC, etc. The multimedia note processing module 312 can also add metadata like the creation time of multimedia note or the location coordinates, speed and heading associated with the multimedia note. The multimedia note processing module 312 also comprises a decoder to decode or decompress the multimedia notes received from server 106.

Storage 308 is a hardware, firmware, software or blended implementation that stores information used by other modules in mobile client device 102. For example, storage 308 stores temporally and/or geographically relevant information received by communication module 310 from server 106. In one embodiment, storage 308 also stores the user interface screens that are either received from server 106 or are preconfigured into mobile client device 102. Additionally, storage 308 can also store multimedia notes 308 generated by a user of mobile client device 102.

Communication module 310 is a hardware, firmware, software or blended implementation that provides a communication channel for various modules in mobile client device 102 to communicate with other entities in system 100. The communication module 310 is communicatively coupled to server 106.

### Example User Interface

FIGS. 6A-6C illustrate examples of user interface screens available on mobile client device 102 for communicating information to and from a user of mobile client device 102. Screen 602 in FIG. 6A displays temporally and/or geographically relevant information received from server 106 in response to a default search criteria or a user specified search criteria. In this example, the result is a restaurant on Lambert & El Camino Real that is 3 miles straight ahead. Section 656 displays the name of the restaurant and the intersection where the restaurant is located. Pointer 654 displays that restaurant is straight ahead and 3 miles away. Icon 652 allows a user to create a multimedia note for the current location of mobile client device 102. The multimedia note can be an audio, visual or a combination of the two types of notes. If the user wants to create a multimedia note, the user can select icon 652 and the user would be led to a screen like screen 604.

Screen 604 displays a countdown timer 658 and a cancel icon 660. The countdown timer indicates the amount of time left before a user of mobile client device 102 can begin creating a multimedia note. The cancel icon 660 allows the users to cancel the multimedia note creation. Once the countdown timer 658 counts down to zero, the user is led to screen 606 in FIG. 6B.

Screen 606 displays a recording screen where the user can record their multimedia notes. Screen 606 comprises a level meter 662, a timer 664 and a visual representation 666 of multimedia note's length. The level meter 662 displays the level of sound or level of brightness for a picture being generated by the mobile client device 102. The level meter 662 indicates to the user to speak up for better sound quality or provide more light for better video quality of the multimedia note being generated. Timer 664 indicates the length of the generated note in seconds and minutes. Visual representation 666 indicates the maximum allowed length of the note and the remaining length of the note that can be generated by a user. After the user has generated a note, the user can stop the note generation by selecting the stop square in level meter 662. The user is then led to screen 608.

Screen 608 provides the user with a number of options on how to handle the note after its generation. For example, screen 608 can inform the user that the generated note is being uploaded to server 106 or one of its databases. In one embodiment, the user generated notes are uploaded instantaneously after being generated. In another embodiment, the notes are uploaded in batches. Regardless of how the notes are uploaded, the mobile computing device 102 displays screen 608 when the notes are uploaded. Icon 668 informs the user that notes are being uploaded. In one embodiment, Icon 668, along with an accompanying label, like “traffic” in screen 608, also informs the users of the classification assigned to their note. The user can use an option (not shown) on screen 608 to select another classification for the note before the client device 102 transmits the note. For example, a user can change the classification of the note from a traffic note available to the entire community to a personal note made available to the user, a selected group, or reserved for uploading to a user specified website. Icon 669 allows the user to post the generated note to a specified website instead of uploading the note to the entire user community.

A message line 670 can inform the user about various status regarding uploading like the number of notes being uploaded, the amount of time left before the uploading is complete or the amount of time left before the uploading will begin. In one embodiment, line 670 comprises instructions to the user like “Select Transmit Icon to Send” if the user selects a new classification for the note, chooses to replay the note before transmitting the note, or does not want the note to be automatically transmitted for another reason. Once the notes are uploaded, the notes are processed, classified and made available for other users of mobile device 102. This processing is explained below in FIG. 4A.

The processed notes can be accessed by other users through screen 610 and screen 612. Screen 610 displays various results of a default search criteria or a user specified search criteria. The user can scroll down for more results through scroll bar 678. Each result displays a description 672a-c of the proposed routes and the amount of time 674a-c estimated to reach the destination through the proposed routes. Screen 610 also comprises a multimedia notes available icon 676a-c. The user can select this icon 676a-c to access all the notes associates with the proposed routes. In one embodiment, the user selects icon 676a and the notes associated with route 280 N. are rendered for the user in a sequence. In another embodiment, the first few notes associated with locations closest to the user are rendered and the other notes are rendered once the user selects the route and approaches the associated locations. In yet another embodiment, additional notes for a selected route are rendered for the user as they become available and/or as the user approaches the associated location.

In one embodiment, selection of icon 676a-c leads the user to screen 612. Screen 612 comprises information 682 about the selected route, a menu 684 listing user generated notes, user information 688 for the user that generated a particular multimedia note, the temporal relevance 686 of the note and the geographical relevance 690 of the note. Information 682 describes the route selected by a user.

Menu 684 renders a list of user generated notes. In one embodiment, the user generated notes are organized by the users who generated the notes. In another embodiment, the user generated notes are organized by temporal relevance and/or geographical relevance.

Temporal relevance 686 renders information regarding the temporal characteristic of the generated notes. For example, the temporal relevance 686 can include information about the time when the note was generated, the amount of time passed since the note was confirmed by another user or the last time the note was updated.

Geographical relevance 690 renders information about the geographical characteristics of the note. For example, geographical relevance can include an intersection, a point of interest or a well known signpost in the neighborhood associated with the multimedia note.

User information 688 renders information about the user who generated the note. In one embodiment, the information comprises a generator's name, a user's picture, alias or a group that includes the generator.

### Example Method For Processing Notes

Referring now to FIG. 4A, it illustrates one embodiment for processing multimedia notes at server 106. In one embodiment, the server configuration may be operational as a cloud network service within a network carrier cloud (e.g., AT&T, VERIZON, T-MOBILE, or SPRINT) or may be operational as third-party service cloud. The user of mobile client device 102 accesses icon 652 on screen 602 and the multimedia note processing module 312 receives and stores 402 a multimedia note generated by the user in storage 308. Next, the multimedia note processing module 312 compresses the note data and adds metadata to the note data. The metadata comprises a time of creation of a note, current location coordinates of the mobile client device 102 when the note was created or associated location coordinates specified by the user through one of the user interface screens, for example, as shown in the screens in FIG. 6A-6C. In one embodiment, the metadata also comprises the current speed and heading of the mobile client device 102, the identity of user who created the multimedia note and/or a group associated with the user, or the identity of the mobile client device 102 and/or a group associated with that device. It is noted that compression can be optional. Compression may provide benefits such as reducing storage space and decreasing transmission time for the note.

After compressing the note data and adding metadata, the controller 302 transmits 406 the note and the metadata to server 106 through communication module 306. The communication module 218 at server 106 receives the transmitted data and forwards the data to content clearing house module 210.

The content clearing house module 210 processes 408 the received note to remove any background audio noise in the note and perform other quality enhancement processes, for example, level equalization and other post encoding processing. The content clearing house module 210 also determines 412 whether the received multimedia note is appropriate for publishing to other users. The determination to publish a note can be based on various filtering criteria that may be predetermined and pre-stored in a database, for example, whether the note is relevant to its specific category, whether the note contains profanity or whether the note is incoherent etc. If the note is not appropriate for publishing, the note is not published for other users and the note is stored 414 for data analysis. Although the note may not be suitable for publishing, the note can be analyzed to determine the note generator's preferences or the note generator's frequently traversed routes. Additionally, in one embodiment, details or other information as to why the note is not published can be transmitted back to the sender as a feedback configuration. In another embodiment, the note is determined inappropriate for a specific category, like traffic or publicly available notes, but appropriate for a different category, like politically incorrect humor, and published as part of that category.

If the note is appropriate for publishing, the content clearing house module 210 optionally determines and adds 418 to the multimedia note additional metadata like length of the multimedia note and quality grade of the multimedia note. The note with its metadata is then stored 420 for later transmission to users.

### Determining and Transmitting Content of Interest

FIG. 4B illustrates an example embodiment for receiving and displaying temporally and/or geographically relevant multimedia notes on mobile client device 102. The user interface module 306 on mobile client device 102 receives 451 a search criteria from the user. The search criteria comprise user preferences for a route. For example, a user can specify search criteria that determine grocery stores on the way to an unknown destination. The user in this case does not specify a destination and expects the mobile client device 102 to render information about grocery stores that are in proximity of her changing location as she drives around.

The user interface module 306 stores the search criteria in storage 308 and informs controller 302 about the received search criteria. The controller 302 retrieves the search criteria from storage 308 and transmits 452 the search criteria to server 106 through communication module 310. In one embodiment, the server 106 stores the received search criteria for later use in the user database 110 and server 106 can use the stored search criteria for later instances until the user specifies new search criteria. In another embodiment, the user does not specify search criteria and server 106 uses a default search criteria instead of a user defined search criteria. In yet another embodiment, server 106 develops search criteria specific to a particular user of mobile device 102 based on the user's previous searches and other uses of the mobile device 102 or user preferences extracted from an external source.

The controller 302 then retrieves the current location of mobile client device 102 from current location module 304 or storage 308. In one embodiment, controller 302 also retrieves speed and the heading direction from current location determination module 304 or storage 308. The controller then transmits 453 the retrieved information to server 106 through communication module 310.

The server 106 determines and transmits to mobile client device 102 the potential content of interest based on location of mobile client device 102 and the received or default search criteria. This determination process is described below in FIG. 4c. In one embodiment, the content of interest comprises multimedia notes generated by other users and the corresponding metadata including location coordinates associates with multimedia notes. The content of interest can be transmitted in multiple layers. For example, server 106 can initially transmit a thin layer comprising metadata associated with the multimedia note and later transmit a thick layer comprising the content of the multimedia note. In one embodiment, server 106 transmits the thick layer as the mobile client device 102 approaches the location associated with the multimedia note. The mobile client device 102 receives the transmitted potential content of interest and stores 454 the potential content of interest in storage 308.

Steps 453 and 454 are repeated several times as the mobile client device 102 moves around. In one embodiment, the mobile client device 102 receives additional potential content of interest from server 106 as additional multimedia notes matching the user's search criteria are generated by other users or additional content matches the search criteria and changed location of mobile client device 102. In another embodiment, the mobile client device 102 keeps receiving additional potential content of interest as the current location of a moving mobile client device 102 keeps changing.

The current location determination module 304 keeps track of the changing location of mobile client device 102 and controller 302 keeps comparing 456 the changing current location of mobile client device 102 with location coordinates associated with stored potential content of interest. If the changing current location of mobile client device 102 comes in a predetermined vicinity of location coordinates associated with potential content of interest, controller 302 determines that the content of interest is geographically relevant and renders the potential content of interest through user interface module 306 for the user. In one embodiment, controller 302 requests server 106 for the thick layer comprising multimedia note once the mobile client device 102 comes in a predetermined vicinity of location coordinates associated with the multimedia note, receives and then renders the received multimedia note.

In one embodiment, controller 302 also determines the temporal relevance of content of interest before rendering the content for a user. Controller 302 therefore searches the metadata associated with a multimedia note to determine if the multimedia note was created or updated before a predetermined time duration. If not, controller 302 determines that the content of interest is temporally relevant and renders the content for the user. Otherwise, controller 302 does not render the content.

A user can request content that does not have geographical relevance or temporal relevance to the user's current location. For example, the user can request a traffic note created by a preferred creator in Chicago, Ill. when the user is currently in San Jose, Calif. In such cases, the mobile client device 102 receives 454 the content of interest and renders 458 the received content of interest for the user. The mobile client device 102 does not determine the geographical relevance of the requested content before rendering the content. In one embodiment, the mobile client device 102 also does not determine the temporal relevance of the received content and renders the content regardless of the content's time of creation.

FIG. 4C illustrates one embodiment for determining content of interest based on current location of the mobile client device 102 and search criteria transmitted from mobile client device 102 to server 106. The communication module 218 at server 106 receives 473 the current location coordinates of mobile client device 102 through communication module 310 at mobile client device 102. The communication module 218 forwards the received location coordinates to location determination module 204. In one embodiment, the communication module 218 also receives a destination location from mobile client device 102 and the communication module 218 forwards the destination location to prediction tree generator 206.

Additionally, the communication module 218 receives a 472 search criteria specified by a user of the mobile client device 102. In one embodiment, the received search criteria are default search criteria, and not user specified search criteria, located at mobile client device 102. In one embodiment, server 106 does not receive a search criteria and server 106 uses a default search criteria stored in user database 110, search space generator 208 or another module in server 106. Regardless of how communication module 218 receives the search criteria, the communication module 218 forwards the search criteria to search space generator 208.

Next, the location determination module 204 locates the received coordinates on a road network map and the prediction tree generator 206 determines 474 the potential routes for mobile client device 102 based on the determined location of mobile client device 102 on road network map. In one embodiment, the prediction tree generator 206 also uses the destination location, heading direction or speed of mobile client device 102 to determine 474 the potential routes for mobile client device 102.

The search space generator 208 then uses the potential routes to determine 476 the search space based on the potential routes. After the search space generator 208 has created the search space, the content of interest determination module 212 determines 478 the geographically relevant content of interest, e.g., content of interest with associated location coordinates that fall within the search space and meet the requisites of search criteria. In one embodiment, the content of interest determination module 212 also considers the temporal relevance of the content of interest, e.g., whether the content of interest was created within a predetermined time of the request or within a predetermined time of receiving the current location of the mobile client device 102, when determining the content of interest. The determined content of interest is then transmitted 480 to mobile client device 102. In one embodiment, server 106 transmits 480 the content of interest to mobile client device 102 in layers as discussed above.

In one embodiment, server 106 repeatedly receives the changing current location of mobile client device 102 and repeats steps 473-480 for various current locations of mobile client device 102. In another embodiment, server 106 repeats steps 473-480 periodically or repeatedly as additional multimedia notes are generated by other users.

The disclosed embodiments beneficially allow for users to generate multimedia notes and associate the multimedia note with a particular location. Other users driving through that location can now access the note and benefit from the note. For example, the multimedia notes can be traffic notes and the users therefore get current traffic information generated by other users instead of no traffic information or stale traffic information. Additionally, the users get traffic information that is directly related to the route being traversed by the users instead of lumped traffic information about a few cities that may or may not have traffic information about the users' route. Moreover, the disclosed configuration provides pinpoint audio “breadcrumbs” within a social network context in that users can leave audio notes or multimedia notes at particular GPS coordinates for retrieval by them or other users at a later point in time.

### Creating and Publishing Web Content with User Generated Multimedia Notes

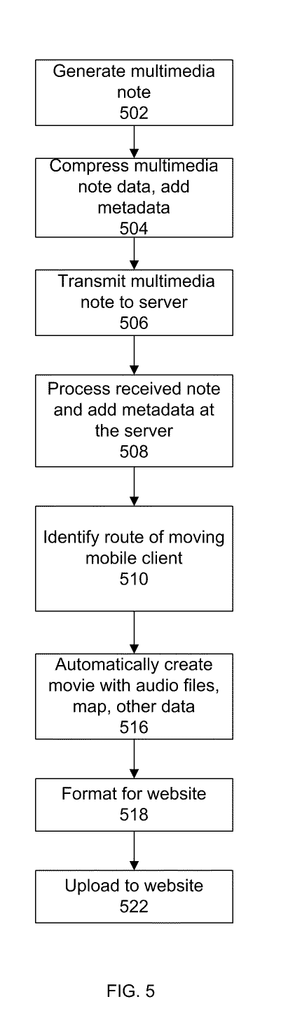

FIG. 5 illustrates an example embodiment for creating and publishing web content with user generated multimedia notes. As described previously, the mobile client device 102 generates 502 a multimedia note, processes 504 the multimedia note and optionally adds metadata to the note. The mobile client device 102 then transmits 506 the processed multimedia note to server 106 and server 106 does 508 additional processing and optionally adds metadata to the note. These steps are repeated for all or most of the multimedia notes generated by a user of mobile client device 102 traversing a particular route during a journey and the processed multimedia notes and metadata for a journey are forwarded to web content generator module 214. In one embodiment, content clearing house module 210 stores the metadata and multimedia notes in a storage that can be accessed by web content generator module 214 instead of forwarding the data directly to web content generator module 214.

Additionally, the location determination module 204 at server 106 repeatedly receives changing current location coordinates of a moving mobile client device 102. In one embodiment, the location determination module 204 keeps track of the changing current location coordinates and uses 510 the tracked coordinates to identify the route of moving mobile client device 102 on a road network map. The location determination module 204 forwards the identified route to web content generator module 214.

The web content generator module 214 integrates 516 the identified route, multimedia notes and corresponding metadata into a presentation like a movie or a flash presentation with a map displaying the route taken by the moving mobile client device 102. The presentation also includes the multimedia notes created at various locations during the journey. The web content generator module 214 uses the location coordinates associated with the multimedia notes to integrate the multimedia notes at appropriate points in the map such that the multimedia notes are rendered when the appropriate points are highlighted in the map. In one embodiment, the web content generator module 214 retrieves geotagged data from external searchable source 114 and also integrates the geotagged data into the presentation at appropriate points corresponding to the location coordinates associated with the geotagged data.

The web content generator module 214 then formats 518 the created content for a web site and forwards the formatted content to web content publisher module 216. In one embodiment, the web site where the content should be published is specified in advance by a user of mobile client device 102 through a user interface like the user interface screens in FIG. 6A-6C. For example, the user can select icon 669 on screen 608 to select an already specified website or specify a website where the note should be presented. In another embodiment, the user also gives authorization for publishing web content on a web site through a user interface like the user interface screens in FIG. 6A-6C. The web content publisher module 216 uses the user's authorization to access the website and upload 522 the formatted content to the web site. In one embodiment, the web content publisher module 216 uses the application programming interface provided by the website to upload and publish the formatted content at the website.

The disclosed embodiments beneficially allow for users to generate multimedia notes with associated location information and present the multimedia notes on a website in form of presentation. The users can beneficially create and publish this presentation with a click of an icon on mobile client device 102 without dealing with the additional effort of creating web content with the presentation and then publishing the web content.

Some portions of above description describe the embodiments of the invention in terms of algorithms and symbolic representations of operations on information, for example, with respect to FIGS. 1, 4A-4C, 5, 6A-6C. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, arrangements of operations may also be referenced as modules, for example, with respect to FIGS. 1, 2 and 3. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

The description about the mobile client device 102, the server 106 assigns particular functions to one entity or a component in the entity. This description and the function assignment are for illustration purposes and do not limit the server or the client to their assigned functions. Upon reading this disclosure, one of ordinary skill in the art will understand that functions described in one embodiment as being performed on the server side can also be performed on the client side in other embodiments if appropriate. Similarly, the client side functions can be performed by the server if appropriate. Additionally, the functionality attributed to a particular component of the mobile client device 102 or the server 106 can be performed by different or multiple components operating together, as deemed appropriate by the implementer.

Upon reading this disclosure, those of skill in the art will appreciate still additional alternative structural and functional designs for a system and a process for generating and accessing temporally and/or geographically relevant multimedia notes through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An apparatus for determining temporally relevant content for a moving mobile client, the apparatus comprising:
a communication module for receiving a search criteria and persistently receiving a current location of the moving mobile client;
a location determination module, communicatively coupled to the communication module, for persistently locating the moving mobile client on a road network map; and
a content of interest determination module, communicatively coupled to the communication module, for determining temporally or geographically relevant content of interest to be transmitted to the moving mobile client, wherein the geographically relevant content of interest is related to the current location of the moving mobile client and corresponds to the search criteria, the temporally relevant content of interest generated within a pre-determined time interval of receiving the current location and corresponds to the search criteria.

2. The apparatus of claim 1, wherein the communication module is further configured to receive new content of interest generated by one or more content generators.

3. The apparatus of claim 1, further comprising:
a prediction tree generator, communicatively coupled to the location determination module, for persistently predicting a plurality of routes that can be traversed by the moving mobile client on the road network map wherein the plurality of predicted routes change with a change in the current location of the moving mobile client, and
the transmitted relevant content of interest is related to at least one of the plurality of predicted routes.

4. The apparatus of claim 1, wherein the pre-determined time interval used to determine temporal relevance of the content of interest vary depending on a type of location associated with the content of interest.

5. The apparatus of claim 1, wherein the content of interest is created by a plurality of users of a plurality of moving mobile clients.

6. The apparatus of claim 1, wherein the communication module transmits to the moving mobile client an initial thin layer and a later thick layer of information about the determined content of interest, the thin layer comprising a content generator identifier and a location related to the determined content of interest, the thick layer comprising the determined content of interest.

7. An apparatus structured to communicate content of interest related to a location of a moving mobile device, the apparatus comprising:
a communication module for transmitting to a server a search criteria, for persistently transmitting to the server a current location of the mobile client, and for persistently receiving the content of interest from the server wherein the content of interest is based on the search criteria and is related to the current location of the moving mobile device or a predicted location of the moving mobile device;
a storage module for storing the received content of interest;
a current location determination module, communicatively coupled to the storage module, for persistently determining the current location of the moving mobile device; and
a user interface module for communicating to a user of the moving mobile device the received content of interest.

8. The apparatus of claim 7, wherein the communication module receives from the server an initial thin layer and a later thick layer of information about the content of interest, the thin layer comprising a content generator identifier and a location related to the determined content of interest, the thick layer comprising the determined content of interest.

9. The apparatus of claim 7 wherein the user interface module allows a user to restrict the received content of interest to content generated by a group of content generators or an individual content generator.

10. The apparatus of claim 7, wherein the user interface module allows a user to record potential content of interest for the current location of the moving mobile device and transmit the potential content of interest to the server.

11. A method for determining temporally relevant content for a moving mobile client, the method comprising:
receiving a search criteria;
persistently receiving a current location of the moving mobile client;
persistently locating the moving mobile client on a road network map; and
determining temporally or geographically relevant content of interest to be transmitted to the moving mobile client, wherein the geographically relevant content of interest is related to the current location of the moving mobile client and corresponds to the search criteria, the temporally relevant content of interest was generated within a predetermined time interval of receiving the current location and corresponds to the search criteria.

12. The method of claim 11, further comprising receiving new content of interest generated by one or more content generators wherein the temporally or geographically relevant content of interest is searched from the new content of interest and from pre-existing content.

13. The method of claim 11, further comprising:
persistently predicting a plurality of routes that can be traversed by the moving mobile client on the road network map wherein the plurality of predicted routes change with a change in the current location of the moving mobile client; and
wherein the transmitted relevant content of interest is related to at least one of the plurality of predicted routes.

14. The method of claim 11, wherein the pre-determined time interval used to determine temporal relevance of the content of interest vary depending on a type of location related with the content of interest.

15. The method of claim 11, wherein the content of interest is created by a plurality of users of a plurality of moving mobile clients.

16. The method of claim 11, further comprising transmitting to the moving mobile client an initial thin layer and a later thick layer of information about the determined content of interest, the thin layer comprising a content generator identifier and a location related to the determined content of interest, the thick layer comprising the determined content of interest.

17. A method for communicating a content of interest related to a location of a moving mobile device, the method comprising:
persistently determining a current location of the moving mobile device;
persistently transmitting, to a server, the current location of the mobile client;
persistently receiving the content of interest from the server wherein the content of interest is based on a search criteria and is related to the current location of the moving mobile device or a predicted location of the moving mobile device; and
communicating to a user of the moving mobile device the received content of interest.

18. The method of claim 17, wherein receiving the content of interest comprises receiving from the server an initial thin layer and a later thick layer of information about the content of interest, the thin layer comprising a content generator identifier and a location related to the content of interest, the thick layer comprising the content of interest.

19. The method of claim 17, further comprising:
receiving a selected group of content generators or an individual content generator; and
restricting the received content of interest to content generated by the received group of content generators or the received individual content generator.

20. The method of claim 17, further comprising:
recording potential content of interest for the current location of the moving mobile device; and
transmitting the potential content of interest to the server.
